(19) United States
(12) Patent Application Publication
(10) Pub. No.: US 2022/0085996 A1
(43) Pub. Date: Mar. 17, 2022

(54) DIGITAL KEY GENERATION FOR ELECTRIC AND ELECTRONIC LOCKS

(71) Applicant: BLE Locking OÜ, Tallinn (EE)

(72) Inventor: Priit VIMBERG, Tallinn (EE)

(21) Appl. No.: 17/020,890

(22) Filed: Sep. 15, 2020

(51) Int. Cl. H04L 9/08; H04L 9/32; G07C 9/00

(52) U.S. Cl. CPC H04L 9/0877; H04L 9/3234; G07C 2009/00412; G07C 9/00309; H04L 9/0825

(57) ABSTRACT

The disclosure is directed to use of digital keys in the control of physical or virtual locking mechanisms. The digital keys may be shared, limited to single or multiple use and may be lock agnostic. The keys may further include instruction to the locking mechanism, a monetary value suitable for prepaid application, and offline usage purposes wherein an electric lock with an external control module or an electronic lock with embedded control module or embedded software component or any virtual lock for controlling the electronic lock are encrypted and are communicated over an encrypted channel to the electronic lock. The commands may be sent from a smart mobile device and be digitally signed for subsequent attestation by the lock for authenticity verification. The digital keys may be generated and otherwise handled under one of a series of escalating security encryption methods typically used and reserved for financial transactions.

### BACKGROUND OF THE INVENTION

The present disclosure generally relates to a controlled grant of access to any physical or virtual location or; and more particularly, to a system and method for generating and distributing digital keys in different security levels, which are configured to selectively control appropriately configured electronic and software modules in a highly secure manner. Although discussed with respect to electric and electronic locks, the modules may also include transport vehicles, such as elevators and motor vehicles, as well as software, virtual domains and the like. For ease of readability, the terms modules, electric and electronic locks will be used interchangeably throughtout.

Electronic locks are well known locks which operate by electric current in place of manual force in the performance of their locking and unlocking function. Both mechanical and electrical locks employ the use of particular keys, the former employing the ubiquitous metal key and the latter employing a digital key and/or an electronic command (e.g. to lock or unlock). Lock operation entails verification that the particular key being used matches or is appropriate for the lock, namely, the key is authentic. For metal keys, such authentication is physical, namely, the user manually inserts the key into the lock and if the key fits, the lock will respond to subsequent commands from the user. For digital keys, such authentication is electronic, namely, the identity of the key may be confirmed on a list of authentic digital keys, the list being searchable by and/or for the electronic lock. If the digital key is authentic, the respective command is excuted by the lock. The physical act of a lock unlocking, for both mechanical and electrical locks, may be essentially comparable, namely, dependent upon a lock bolt holding or freeing a sliding bolt work with respect to a frame or other holding structure. Other lock configurations may be envisioned by the skilled person. Application of electronic locks has been taken up in recent times to include private homes, businesses, government installations, lockers, garages, gates and the like.

Digital keys offer certain advantages over mechanical keys, including ease of creation, distribution and management given, at least, the keys fundamental electronic nature. For example, digital keys may be created by appropriately configured computer systems, distributed via standard messaging protocols and managed with appropriately configured database software. Such becomes difficult if not impossible with respect to mechanical keys. Further still, with the key authentication process being based on electronic recognition between communicating electronic devices, electronic security measures such as encryption may be employed. Here, digital keys may form an integral part of the encryption process with the public key/private key being a known example. Whereas mechanical locks may be picked with widely available tools and available knowledge, hacking modern encryption methods requires particular computing tools and highly specialized knowledge thus making it far more difficult than its mechanical lock picking counterpart. In addition, digital keys can be assigned the time of validity, so they can be used only in certain time frames assigned to the respective key by a key distributor, which is not possible with mechanical keys. Electronic locks have also benefited from the widespread uptake of smart mobile devices, networked locations and advancements in the computer arts, making electronic locks more available, in more variety and at reduced costs. Unsurprisingly, electronic locks have gained in popularity with a variety of applications spreading from governments to businesses to the private sector. With this increase in popularity and use, comes the need for ever increasing security measures in order to protect the integrity and workings of the electronic lock as well as a general increase in ease of use and flexibility for still more application. Such fundamental and continuous needs may also be applied to the other application of modules as for example listed above.

### BRIEF SUMMARY OF THE INVENTION

The present disclosure is directed to improving the security and operation of modules, such modules including electronic locks. Whereas known solutions for secure and usable locks entail use of a single digital key of modest singular security and distribution parameters, a feature of embodiments of the present dislcosure include applicaion of heretofore unapplied different security levels to numerous digital keys for enabling access to wide range of physical and digital solutions, including electronic locks, through the application of numerous encryption and encryption related methods during the preparation for and execution of locking and unlocking commands. Embodiments of the present disclosure include the generation of digital keys at selected levels of security heretofore found in financial and banking applications. Such digital keys may be used in communicating with proprietary locks confirmed to communicate with proprietary software distributed to a user in advance of operating the electronic lock. The software may be installed and run on a smart device, such as the ubiquous smart phone, remote control and the like which includes sufficient processing and communication features to enable wireless communication with the proprietary locks. The communication is impacted by the running the software in order to establish an channel of communication with the lock. The software further enables user registration, user association with the lock, appropriate key generation with possible limitations of key usage for specific times and number of key usages and effective encrypted communication with the lock via the encrypted channel where also channel encryption keys are generated, distributed and managed by the system, making the modules visible only to the users who are holding the digital keys for the module. Still further, some or all of the electornic communications discussed herein may further be encrypted to ensure reliability and security thereof.

Embodiments of the present disclosure are further directed to a backend or capable frontend in standalone offline situations, configured to generate the digital keys in cooperation with a frontend and modules which may include the user's smart mobile device and the electronic lock. Other electronic devices capable of communicating with the backend may be envisioned within the scope of the present disclosure, including third party computers executing enterprise solutions. User communication is facilitated by the user's smart mobile device running the aforementioned software. Through such communication, the user may register, request or generate a personal and unique digital keys, execute commands on the electronic lock and so forth. The requested digital keys may be generated by variety of security and encryption methods. Keys may be asymmetric and include public and private keys with the backend further including a proprietary Certification Authority for attesting to the validity of the public keys when queried by online electronic locks. Offline locks may include local functionality to authentic asmetric keys. Likewise, the digital keys may be symmetric, with the authentication of same being made similarly to the aforementioned. More advanced keys may be use quantum encryption technologies. As embodiments may be applied not only to electronic locks but also other smart modules, attestation requests may be fielded from any of the aforementioned modules. In application, the digital keys may be used by the smart device, running the software, to digitally sign and transmit commands and other needed instruction information from the user to the lock which, after the keys are authenticated, may be executed by the module.

By way of embodiments of the present disclosure, the keys generated may be unique for each user as well as for each smart mobile device. Accordingly and dependent of the security level of the key, the same key cannot be transferred or otherwise reproduced for effective use on other devices. The backend may further include key generation parameters and management. The parameters include a select one from a plurality of increasingly secure encryption methods generally reserved for the financial industry and financial transactions. Key management includes logging user requests and key generation along with key revocation, blacklisting and the like. Changes in key status may be communicated to the modules through various means, including direct online communication for online modules, encrypted channels similar to the aforementioned and piggybacking on other smart devices. Key generation may be made on user's smart device or over a safe public cloud infrastructure while the aforementioned backend may be resident on a Virtual Private Data Center (VPDC) with controlled access thereto. The number of keys generatable by embodiments of the present disclosure is limited only by the smart device memory configuration and storage capabilities. Accordingly, in some embodiments, the number of keys can run into the hundreds or thousands. Finding of the right key from possible hundreds or thousands of keys in users posessions may be made easier via location based functionality wherein particular keys are associated with particular locations within the processing means of the smart device. Locations may be based upon GPS coordinates, cell tower triangulation or broadcast methods on lower range wireless connections and the like as may be envisioned by the skilled person. Activation of such automatic key association functionality may be made by bringing the smart device into communication range with a particular module, shaking the smart device, and any other activation method as may be envisioned by the skilled person. As the electronic locks and software running on the smart device are proprietary, such may be preconfigued to cooperate accordingly. Those helper methods, like automatic activation of sending the key to the electronic lock have special purpose for users with disabilities who can initiate automatic opening based on diferent helper functions. Key requests and usages may be stored in a data warehouse which may be encrypted so as to be accessible only by key generators and policy servers. Keys can be generated anonymously for user privacy protection purposes. Key generators may have key-on-demand function to initiate key generation by specified authorities or other entities. Those functions enable scenarios where keys will not be in users device all the time for privacy or security reasons and keys will be generated and/or distributed just before the need of access. This is specifically needed by risk organisations and care givers or highly secured establisments to minimize the damages on entrance to premises where users need emergency help. Systems may have log engines to track the usage of every action, generation, event and the like that happens in system backend, frontend or in modules. Log analyzers may further include read-only access to data, with the data anonymized and coded via indexes of locks and users.

The frontend may further include proprietary smart modules, online or offline, being in a closed system with the backend. The modules may be preprogrammed to recognize particular queries generated by smart mobile devices running the aforementioned proprietary software and set up an encrypted communication channel therewith. The modules may further include their own digital keys to enable the encrypted communication and the modules may generate the keys for its communication and key exchange with any smart device.

Embodiments of the present disclosure are further directed to methods for creating and using digital keys when communicating commands to modules. The methods may include preconfiguring modules to appropriately and/or via encrpyption communicate with the smart devices running proprietary software. Keys may be generated locally at the smart device in cooperation with the backend and module as well as in the backend, upon request from the software. The steps of the methods may include enabling communication between module and smart device; communicating from the module to the smart device a digital key for authenticating at the module offline or online; communicating to the smart device a confirmation of authentication which in turn prompts the smart device to communicate commands which upon receipt at the module are executed and confirmed.

The communication between the smart device and module may be an encrypted communication channel set up with asymmetric keys. For example, such method may include enabling communication between module and smart device; exchanging a public key either from module to smart device or visa versa; attesting the public key; and encrypting subsequent communications with the attested public key, the subsequent communications including module commands and confirmations of their receipt and execution.

A further feature of embodiments of the present disclosure include the communication of maintenance information with the modules. Where the modules are online, such communication may be enabled accordingly. Where such modules are offline, such communication may be taken up by the user's smart device and other smart devices registered, authorized and/or otherwise associated with the module so as to deliver updated maintenance information thereto. Maintenance information may include updated digital key status, attestations, timing, clock and other data as may be envisioned by the skilled person.

### BRIEF DESCRIPTION OF THE SEVERAL VIEWS OF THE DRAWINGS

The accompanying drawings, which are incorporated in and constitute a part of this disclosure, illustrate exemplary embodiments and, together with the description, serve to explain the disclosed principles.

FIG. 1 depicts a high-level view of architecture employable with embodiments of the present description;

FIG. 2 depicts a process flow for the generation of digital certificates and the communication of signed communications with an online electronic lock;

FIG. 3 depicts a digital key generation architecture according to embodiments of the present disclosure;

FIG. 4 depicts a process flow of requesting digital keys and using them to facilitate communication between smart device and electronic lock;

FIG. 5 depicts provision of maintenance information to an offline module;

FIG. 6 depicts a method method for communicating between a smart mobile device and a module according to embodiments of the present disclosure;

FIG. 7 depicts another method method for communicating between a smart mobile device and a module according to embodiments of the present disclosure; and

FIG. 8 depicts yet another method for communicating between a smart mobile device and a module.

### DETAILED DESCRIPTION OF THE INVENTION

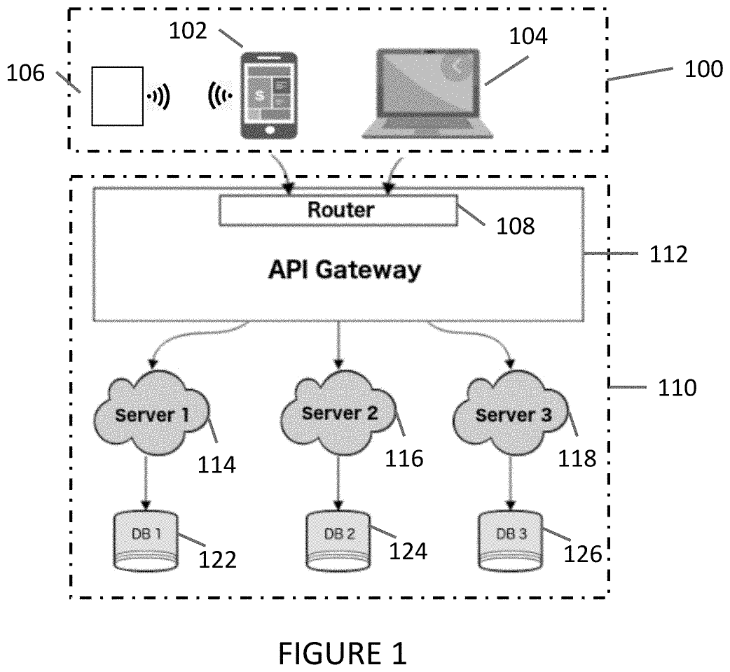

A system architecture which may be employed by embodiments of the present disclosure is depicted in FIG. 1. As shown, a frontend 100 is depicted including an enterprise user 104 and a smart mobile device 102 in communication with a module 106. Frontend 100 is arranged and configured to be in communication with a backend 110. The frontend may include any number of smart devices with the depicted device being a smart phone by way of example only. As shown, smart mobile device 102 and enterprise user 104 are arranged in communication with a router 108 and API gateway 112 located in the backend 110 and configured to selectively direct incoming traffic to at least a select one of three servers 114, 116, 118 running applications thereon and in communication with an own database 122, 124, 126 respectively. Any number of communications within or between the frontend and backend may be encrypted. Routers are well known in the computer arts as a networking device configured to forward packet data between computer networks, while API gateways are known servers which may act as API front-ends for receiving API requests, enforcing throttling and security policies and passing requests to backend services and responses back out to respective requesters. The aforementioned communications may comprise API requests. Accordingly, a user in the frontend is in communication with applications running in the backend. Such applications may include those devoted to digital key generation; user, permission and device management; online device monitoring, procurement and firmware updates; and 3^{rd} party solutions. In order to ensure secure communications between user and module, cryptographic systems may be employed in key generation and creation of an encrypted communication channel between user and module.

Digital key generation is a well-known process in computer cryptography which essentially uses integers for keys. The keys may be randomly generated using for example known random number generators or pseudorandom number generators—a computer algorithm that produces data that appears to be random when under analysis. Sizes of keys may also vary with larger keys being employed when greater security against discovery is desired. By way of embodiments of the present disclosure, the keys are generated according to pre-selected security levels which may correspond to those typically associated within the financial services industry, such as with financial transactions. For example, the key generation may be secured and performed by a dedicated private hardware solution in a backend with such generation being selectively made in accordance with the Payment Card Data Industry Security Standards (PCI DSS) as well as by certified HSM. For example, a highest selectable security level may conform to nShield FIPS 140 Level 3 HSM (Hardware Security Module) key generation while a standard security level may conform to the nShield FIPS 140 Level 2 HSM (Hardware Security Module) key generation. Application of other security levels are envisioned. Various asynchronous and synchronous cypto algorithms as well as certain hash algorithms are supported while the lengths and encryption algorythms of the keys may vary depending upon the select security level employed.

Cryptographic systems, employable by embodiments of the present invention, may include symmetric as well as asymmetric key algorithms. Initial keys may be generated locally in the frontend and module or remotely in the backend. In particular, the keys may be generated at the front end by a smart mobile device or module, as well as in the backend by an appropriately configured server, as may be dependent upon the policy implements for certain key security levels. In addition the key exhange may be affected in higher levels of security where an initial key is sent to a smart device and after initial use the module will generate a new key along with other such confidences between smart device and module. Accordingly, from this moment onwards, only the module and smart device have knowledge of the keys and confidences or secrets for the next lock opening. The key generation at the module is enabled by proprietary software configured to cooperate with the appropriately preconfigured module, the key generation occuring as part of the module registration process with the back end, itself enabled by the smart device and/or online module, or as part of a communication between smart mobile device and module. Additionally, initial digital keys may be generated offline between the module and smart device by triggering initial key exchange via the sharing of a secret, for example, through scanning a QR-code with the instructions to get access to the secret.

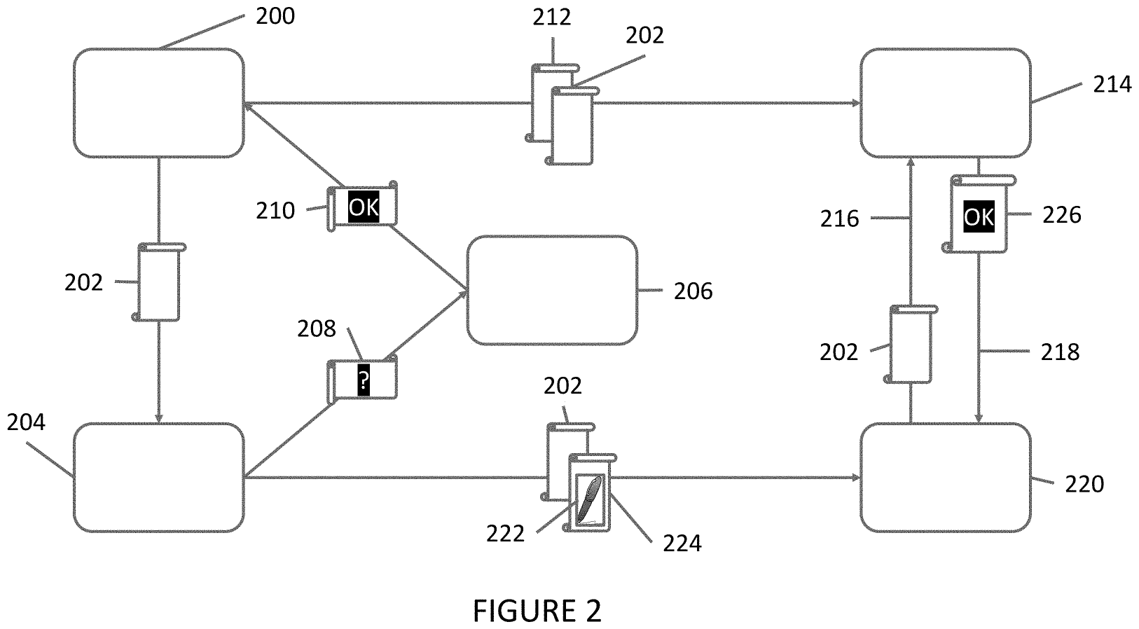

Symmetric key based communication makes use of a single shared key which is kept secret and used to encrypt and decrypt messages. Asymmetric key based communication uses a public key/private key combination wherein the public key may be openly made available and used to decrypt data encrypted with the private keep which is keep in secret. Here, a sender encrypts a message with the receiver's public key; only the holder of the private key, in this case the receiver, can decrypt this message. Attestation of the public key is obtained from the certification authority during the decrypting step in order to ensure that the public key validly belongs to the receiver. To this end, embodiments of the present invention employ Public Key Infrastructure (PKI) best practices while offering a proprietary Certification Authority (CA). Here, message and data are used interchangably with the understanding that the skilled person when applying the aforementioned would understand that both and/or either of the message and data may be encrypted with at least one of the symmetric and asymmetric keys. A process flow of using such best practices is set out in FIG. 2.

Embodiments of the present disclosure are further configured to support any one or more of the following: asynchronous crypto algorithms RSA, Diffie-Hellman, ECMQV, DSA, KCDSA, ECDSA, ECDH and Edwards (X25519, Ed25519ph); synchronous crypto algorithms AES, AES-GCM, ARIA, Camellia, CAST, RIPEMD160 HMAC, SEED and Triple DES; and hash algorithms SHA-1, SHA-2 (224, 256, 384, 512 bit) and HAS-160.

As is known in the art, PKI is a set of roles, policies, hardware, software and procedures needed to create, manage, distribute, use, store and revoke digital certificates as well as manage public-key encryption. Its purpose is to facilitate secure electronic transfer of information through the binding and authenticating of public keys to and with respective entities. Example public key infrastructure and process flow of the implementation of the same is depicted in FIG. 2. As shown, certification authority (CA) 200 is configured to register and issue digital certificates 202 for requesting users 204. Here, the CA has delegated public key vetting and validating to a registration authority (RA) 206, including: identification and authentication of certificate applicants, approval or rejection of certificate applications, initiating certificate revocations or suspensions under certain circumstances, processing subscriber requests to revoke or suspend their certificates, and approving or rejecting requests by subscribers to renew or re-key their certificates. Alternatively, RAs may be dispensed with, as in the case of standalone CAs, or offered as stand-alone components. As depicted, user 204 requests 208 a digital certificate from the RA 206 which, upon authentication of the user 204, issues an approval 210 to the CA 200 which in turn generates and sends the certificate 202 to the user 204. Likewise, the CA keeps a validation authority (VA) 214 informed of current and valid registrations 202, 212 for the VA to subsequently use in validating 218 attestation requests 216 from an entity 220. The entity, as will be detailed hereafter, may include the instant module, and an electronic lock in particular. In addition to a list of valid certificates, the VA may host a list of revoked certificates which, in effect, returns an invalid attestation thereby causing the entity to doubt the authenticity of the underlying request. Further still, such list may be stored in an appropriately configured module and uploaded as part of maintenance information either directly when the module is an online module or via smart devices associated with the module during the normal usage interaction with module by the user or via specific maintenance function in smart device. As depicted in FIG. 2, the user 204 communicates a digitally signed 222 command 224 and public key 202 to entity 220 which in turn requests 216 the VA 214 to validate the public key 202. For offline modules, such requests would be processed internally. As depicted, VA validates 226 the certificate and communicates 218 the validation back to the entity which now understands with a greater degree of certainty that the communication 224 originated with the user 204. Likewise, should the public key be revoked, the VA would return a negative attestation thereby resulting in the entity doubting the communication. Returning to FIG. 2, accordingly, the communication 224 may be safely processed by the entity 220. Assuming that the sender signed 222 the communication 224 with its private key, the entity 220, now in possession of the attested public key 202 may use it to decrypt the communication to arrive at the content thereof.

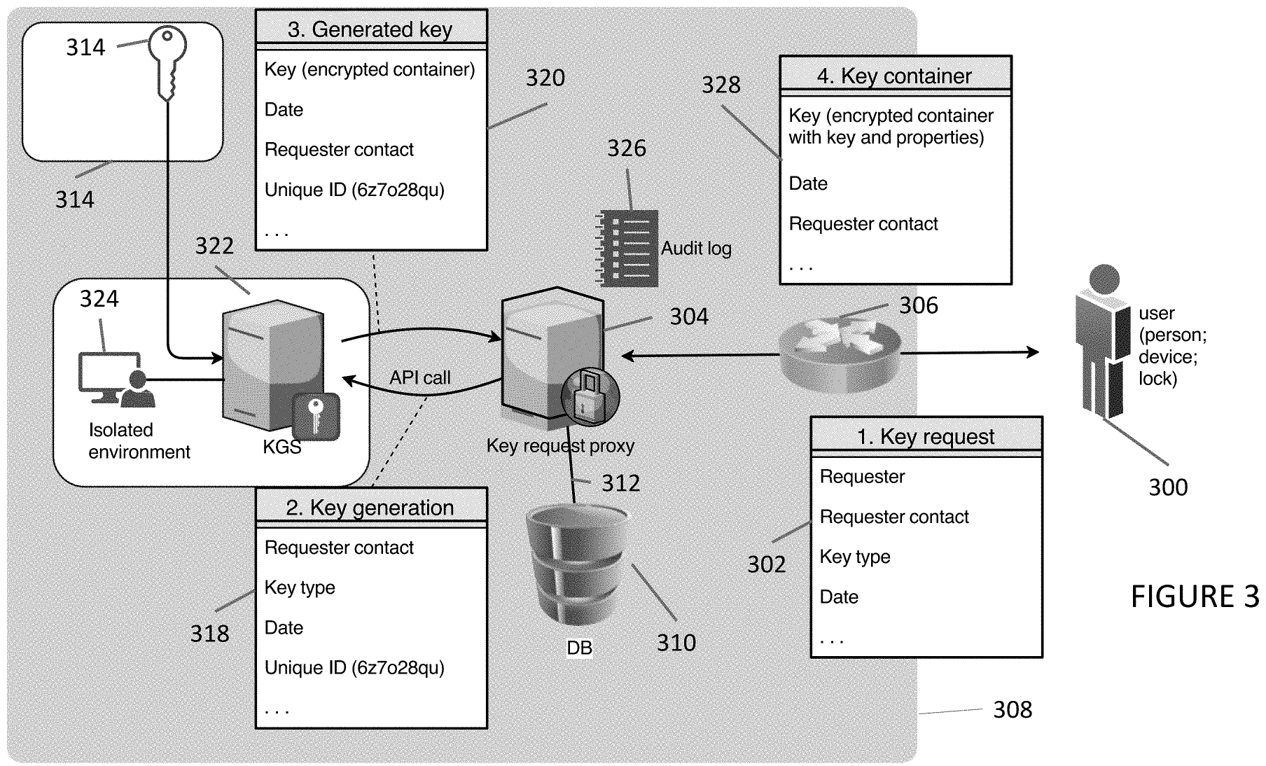

FIG. 3 depicts key generation architecture according to embodiments of the present disclosure. As shown, a key request 302 from a user 300 in the frontend comes into the key request proxy 304 via a router 306 arranged in the backend between the user 300 and the key request proxy. The router 306 may comprise a network router and further include a firewall as well as be configured to be a network device and/or gateway into network 308. The key request proxy 304 includes direct access 312 to a database 310. The database 310 may be configured for use with audits and may hold information about who has permission to get what keys to which environment. For example, if there is a permission record in the database, then a key may be generated according to those permissions (rules). In addition to the keys that are used to communicate commands, e.g. lock/unlock, the key generation service may also generate keys for encrypting communication channels, software inside the modules, as well as software and its components residing on the smart mobile devices. Audit logs may be separate services (component 326) configured to track and log every event that happens in the system. The proxy 304, via an API call, requests a key to be generated 318 by the key generating server 322 which may operate in an isolated environment 324, such as in a separate Virtual Private Data Center (VPDC) with controlled access thereto, for enhanced security purposes. The requested key is then generated by the key generating server and extracted from vault 314. The vault may include a master key 324 which may be used to sign the digital key generator to generate the keys as well as with different generators for different levels of security based upon different encryption algorithms. The master key 324 may be physically stored in a safe in a USB or other physical medium. The generated key may be communicated back 320 to the proxy 304, where it is logged 326, packaged 328, and communicated back to the user 300 via router 306.

All requests and activities may be saved in a data warehouse which is encrypted and which may be accessed only by key generators and policy servers. Log analyzers may be employed, with the analyzers having read-only access to data, while the data may be anonymized and coded via indexes of locks and users. The keys generated are unique for every user and their respective smart mobile device. Accordingly, the same key cannot be transferred for use in or on another smart mobile device, even if such belongs to the same user. Keys may be revoked in the backend (e.g. revocation of their digital certificate) rendering the key unusable. Appropriate measures are in place to communicate such revoked or blacklisted keys to online as well as offline locks or modules. Such may include affecting such communication directly or via the proprietary application running on the user's mobile device. The number of keys generated becomes limited only by the capacity of the mobile device to accommodate them.

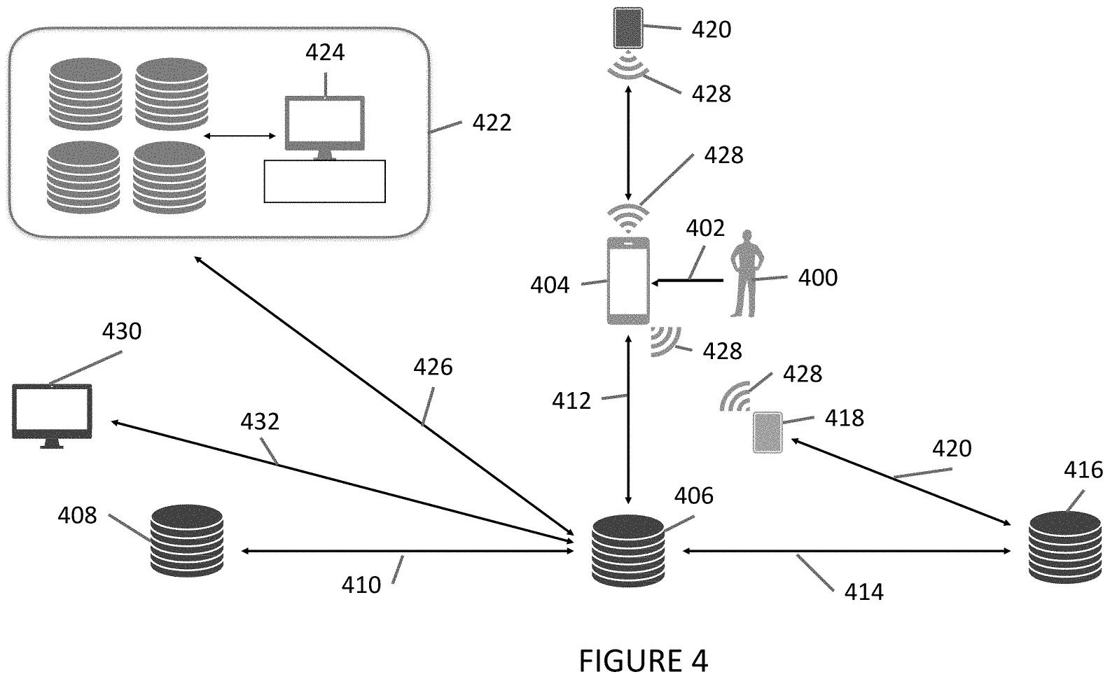

FIG. 4 depicts a process flow of obtaining a key and making use of same in accordance with embodiments of the present disclosure. Although a disruptive flow management scheme is depicted, other schemes may be employed as envisioned by the skilled person. As shown, user 400 downloads 402 a proprietary software application to its smart mobile device 404. Other software acqusitions arrangements may be considered as would be envisioned by the skilled person, including by invitation. The software may be available from any envisioned software source, including online means and physical acquisition. The application is installed and run on smart mobile device 404. As part of the installation process, the user completes and sends off a registration 412 to the backend. The registration is directed, via an API, to a first application 406 configured for saving and obtaining a digital key personal to the user, as well as manage user identification, permissions and devices. Such application may be running on a server and include API gateway and routing functionality.

When registered, the user may become the module owner and will receive a key to use the module. Alternatively, the user may receive the key from another module owner. If the user is the module owner, the user will use their smart mobile device to identify the module intended for tie into the user's account. The identification may be effected by scanning a QR code and the like present on the module or via other similar such identification means. Such identification may find application with offline module 420 or online module 418. Once identified, the module is also registered in the first application 406. Registrations may be stored in a database, an example arrangement for which is depicted in FIG. 3 and discussed above.

The first application 406 proceeds to obtain 410 from a second application 408, via an API, the generation of the digital key for the user along with any related and/or proprietary applications and modules as communicated within the user's registration. The generated digital key may be then related to the registered module and generated by the example arrangement set out above. The second application 410 may also be running on a server and include appropriately configured functionality to generate digital keys in accordance with embodiments of the present disclosure. The first application 406 further requests 414, via an API, device data and, optionally, module opening or unlocking via LAN, etc. with digital keys from a third application 416 running on a server and appropriately configured to be tasked with online device 418 monitoring 420 procurement and maintenance information updates. The module opening may be obtained for online modules responsive to online commands instigated by at least the third application 416 or for offline modules (420) as may be instigated as part of the registration process or subsequently thereafter in order to facilitate ease of use.

An administration tool to at least monitor logs and manage users, devices and permissions may be appropriately configrued and arranged in communication 432 with the first application 406. Lastly, the first application 406 may exchange user and key information, though not necessarily the digital key itself, with third party solutions 422 which, as connected via an API 426, may also grant access, generate keys and revoke keys as depending upon particular solution and administration 424 thereof. The digital keys may now be sent back (412) to the mobile device 404 for use in communication with a module. Two modules, electronic locks, are depicted, an offline lock 420 arranged in communication 428 with mobile device 404 and an online lock 418 also in communication 428 with mobile device 404 but also in networked communication with the aforementioned applications. The communications 428 may be proximity based and comprise any communication standard envisioned by the skilled person.

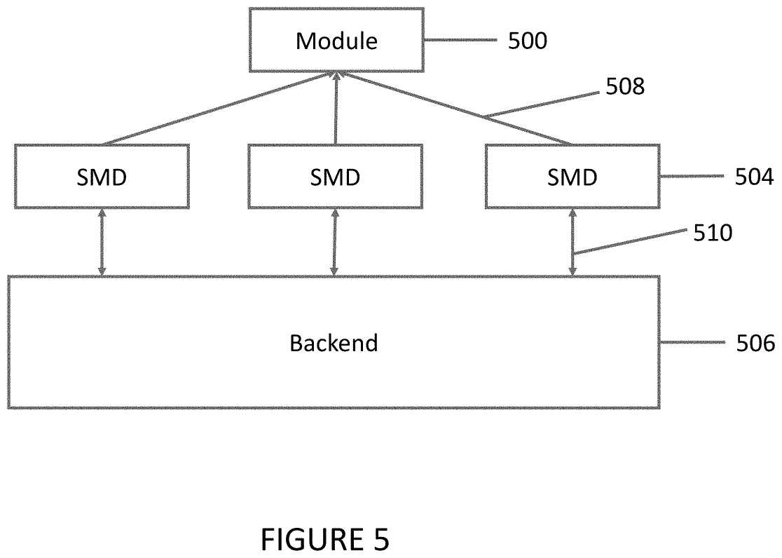

Modules, according to embodiments of the present description, may be maintained with provision of maintenance information. Such provision may be regular, periodic or ad hoc. While online modules may receive maintenance information, such as timing, clock, firmware update and blacklisted keys, from the backend by virtue of their respective online connections, offline modules receive such information via maintenance channels set up between smart devices, as affected by the proprietary application running thereon, and the offline modules. Online modules may also receive maintenance information accordingly. FIG. 5 depicts maintenance channels with an offline module (500) which may be affected by displensing the maintenance information to one or more smart mobile devices (502) registered for use with the particular offline module (500). Such information would be known from the maintained database log within for example the backend (504). The smart mobile device(s) (504) would then impart the maintenance information to the offline module when next in communication (508) therewith. For example, a communication may be made between the backend and the smart devices (510) that a particular key is now blacklisted. If or when any of the smart devices (504) come into contact or communication (508) with the module (500) thereafter, as part of the normal locking/unlocking communications detailed above, the smart mobile device (504) would automatically deliver an update to the offline module list of blacklisted keys via the communication (508). The offline module (500) in turn would then update its list accordingly. Maintenance information may be communicated from a single smart device to the offline module or via a series of smart devices (as shown), each delivering a portion of the overall maintenance information. The offline module (500) may in turn be configured to receive information, whole or piecemeal, reassemble such information as may be needed, and update its store of information with the new information accordingly. Further still, once the maintenance information has been communicated, the offline module (500) may communicate back to the backend (506), a confirmation of the update and/or simply instruct the smart mobile device to delete the maintenance information currently therein. The proprietary software application described above and currently running on the smart device (504) in this example facilitates the aforementioned communication without engagement or input required from the user. Alternatively, the user may be afforded the opportunity to consent to such maintenance information sharing. Both the maintenance information and the channel of communication via which it is communicated to the module may be encrypted. The aforementioned may also be applied to online modules.

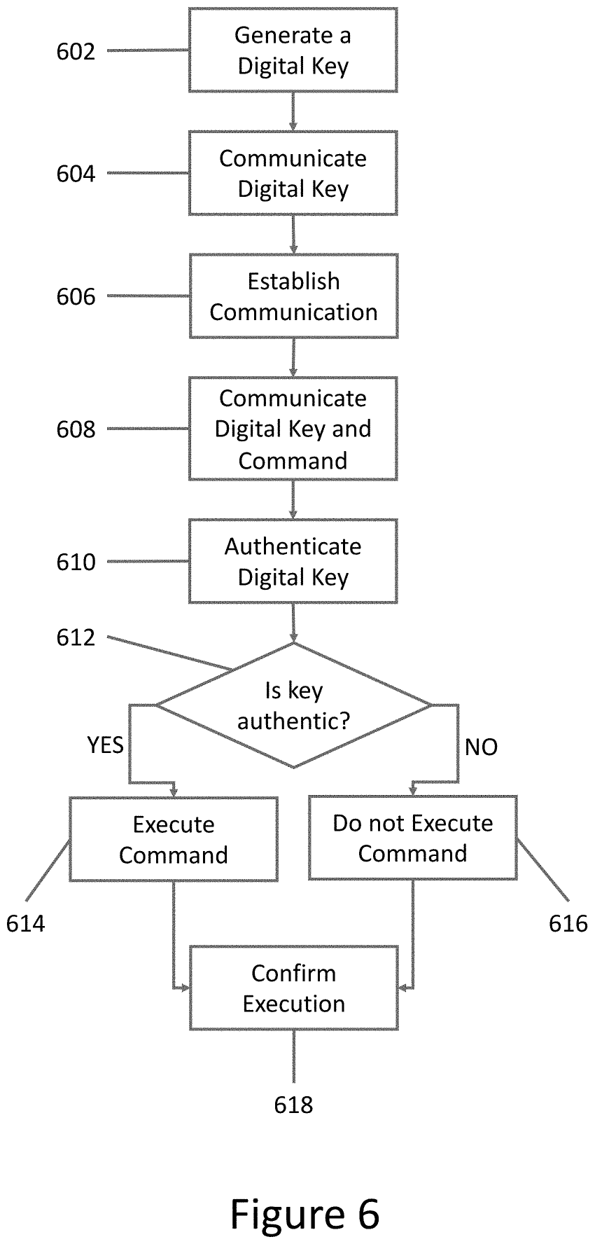

A method for communicating between a smart mobile device and a module is set out in FIG. 6. By way of an initial step 602, a digital key is generated on behalf of a registered user and then communicated to the user (step 604), the aforementioned may be as detailed above. By way of alternative, the smart mobile device may be preconfigured with one or more digital keys, such preconfiguration activated as part of the registration process or another process in order to bring the one or more digital keys into an active use mode. Communications may be affected with one digital key or a plurality of digital keys as envisioned by the skilled person. The smart mobile device is brought sufficiently proximate to the module (step 606) so as to enable an electronic communication therebetween. The electronic communication may be of any communication standard known to the skilled person suitable for the respective smart mobile device, itself suitably configured and enabled for such communication standard. The communication between smart mobile device and module may selectively be encrypted. With the registration of the module to the user, the type of key to be used in authenticating the user, via the proprietary software, becomes known in advance to at least the proprietary software running on the smart mobile device. Accordingly, once proximate to the module, the smart mobile device may automatically (by virtue of the proprietary software running thereon) or via manual prompting (by virtual of manual activation of an appropriate feature of the proprietary software running thereon), communicate the digital key to the module (step 608) via the aforementioned electronic communication. With receipt of the digital key, the module in turn authenticates the key (step 610). For offline modules, such authentication may occur entirely locally, with local processing components receiving, identifying and verifying the received digital key against a list of authentic digital keys maintained on the offline module by virtue of communicated maintenance information. For online modules, such authentication may occur locally or remotely by design, such as for example detailed above with respect to the attestation of public keys. A determination (step 612) is then made whether the received digital key is authentic (Yes) and if so command(s) received from the smart mobile device in conjunction with the authentic digital key are executed (step 614). Likewise, where the determination is that the digital key is not authentic (No), then the command(s) are not executed (step 616). By way of a next step, the execution of non-execution is confirmed back to the smart mobile device (step 618).

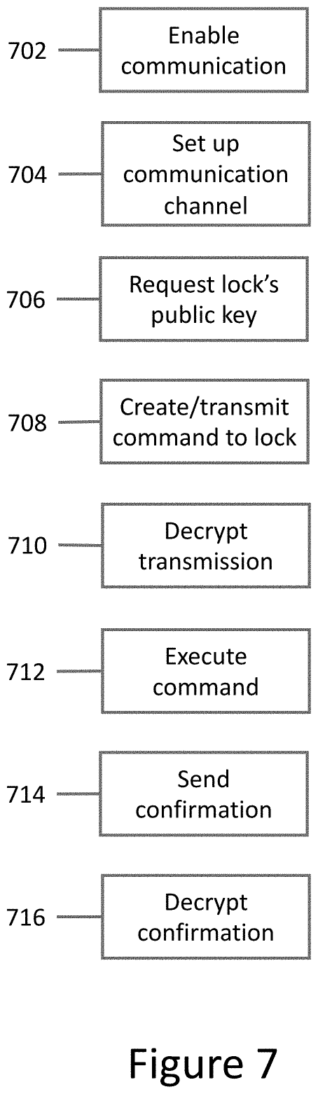

Another method according to an embodiment of the present disclosure is set out in FIG. 7. The method begins at a first step 702 wherein communication is established between the smart mobile device and electronic lock. Such communication may be established by the physically bringing of the smart mobile device into sufficient proximity with the electronic lock so as to enable an initial exchange and/or communication therebetween using known standards and procedures for such communication. For example, such communication is depicted in FIG. 4 as signal broadcasts 428. Returning to FIG. 7, with communication enabled, an encrypted communication channel may be set up (step 704) between smart mobile device and module. The heretofore downloaded proprietary application may enable the setting up of the encrypted communication channel, such operationally being further facilitated by the module also being proprietary and appropriately pre-configured, as well as through data exchanged during the initial contact between the smart mobile device and module. Once established, a request is made to the module from the mobile device for the lock's public key (step 706). Once armed with the public key, the mobile creates a command, such as “unlock” and/or “open” or other specific command as an instruction for the module depending upon application thereof. For example, when applied in an elevator or other moving vehicle, such command may include a destination. The smart mobile device signs the command using the private key, as may be obtained as per FIG. 4, and transmits the signed command, along with its public key, to the module, the transmission being further encrypted with the module's public key (step 708). At the module, its pre-programmed (or newly provided as may be the case for at least online modules) private key, associated with the communicated public key, is used to decrypt the transmission which was previously encoded, by the smart mobile device, optionally running the proprietary software and/or using other appropriate softwre, with the module's public key. At the module, the public key received in the transmission is attested (as per its digital certificate) and if found valid, used to decrypt the transmission (step 710). If the transmission is not attested, a number of retrys would be attempted followed by an error message to the smart mobile device if such attemtps also prove unsuccessful (not shown). The command in the transmission is then executed (step 712) and a confirmation of the same is generated, encrypted with the lock's private key and transmitted back, along the encrypted channel, to the mobile (step 714) which then uses the lock's public key, already in its possession, to decrypt the confirmation (step 716). The aforementioned has been set out with respect to an offline module, however, it may also apply to online modules, wherein the appropriate processing capabilities normally resident on the offline module may be alternatively located remotely and online. Additionally, functionality, such as automatically opening the online electronic module during the registration process (as described above) may be executed. Likewise, the module may broadcast its public key and the mobile device and lock may simply communicate using public/private key messages absent the encrypted channel. The module in this and other examples may include an electronic lock.

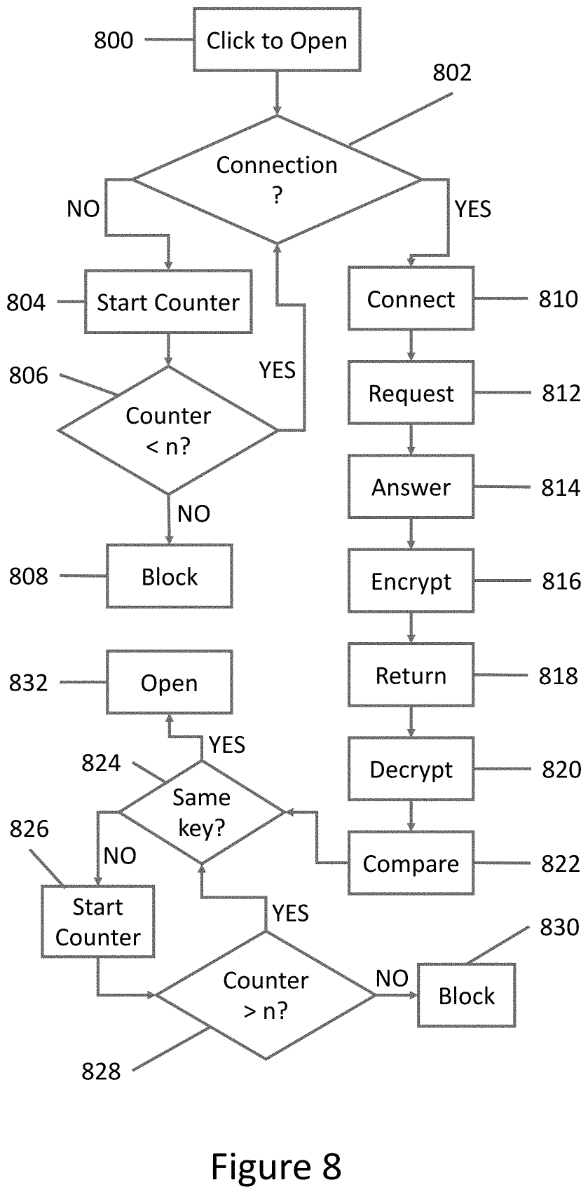

Another method according to another embodiment of the present disclosure is set out in FIG. 8. Application of this another method may be with respect to an electronic lock for a gate (hereinafter referred to as a module). Prior to the start of the method as depicted, the user has downloaded and is otherwise running the proprietary software on a smart mobile device. The smart mobile device is either brought proximate to the module and automatically requests the gate to be opened or is manually activated by the user (step 800). The proprietary software application scans for nearby modules which are enabled for communication with the smart mobile device. Such communication may be targeted with advance knowledge known to the proprietary software by virtue of pre-programming along with location information available from the smart mobile device. Here, the communication may be for example a search for a Bluetooth entabled module having a particular Bluetooth name such EHG0AA01. When found, a connection with the module from the smart mobile device is attempted (step 802). If the connection set up fails (No), a counter within the proprietary software may start (step 804), run for n number of retries (806) which if still fail (No) will block future connection attempts. If a retry is successful (Yes) or if the initial try is successful, the method continues to establishing a connection (step 810) and when the proprietary software has a connection to the module, the proprietary software sends a request (step 812) to the module which is then answered (step 814) with a randomized string, such as 1257282715093802. The proprietary software would then (step 816) use an AES algorithm to encrypt the randomized string with a users' key which may be stored in a database and on the module so as to optionally only be known to the proprietary software and the module. In particular, the users' key is not known to the user. The key may optionally not be transmitted over the air. Returning to the method, the encryption may appear as follows:

$$1257282715093802 \; 3144969151781450 = g 0 czibdmahfh 5 m 793 ptvtm 871 oqb 6 q k q$$

The above result is communicated back (step 818) to the module which then decrypts the result (step 820) with the known user key. Such may appear as follows:

$$g 0 c z i b dmahfh 5 m 793 ptvtm 871 oqb 6 qkq 3144969151781450 = \\ 1257282715093802$$

The module then compares the aforementioned second result with the aforementioned randomized string (step 822). Where there is a match (YES), the module would know that the aforementioned was encrypted with the same user key and the module triggers the command, such as opening the gate (832). Where there is not a match (NO), a counter is started (step 826) for execution of a number of retries (828) of step 724 which, if any are successful (YES) result in the command being executed (step 832, gate open). Alternatively, the number of retries may be time based. The module may have one master key, while the user may have at least 99 unique user keys.

While application of embodiments of the present disclosure are set out above with respect to the modules being online and offline locks, other embodiments may be envisioned. For example, an embodiment of the present disclosure may be applied to the controlled access to software. Such access may pertain to the initial installation on a suitable device, access to software already running on a device and the like.

Further embodiments may include application to elevators and other such transportation means wherein a particular interaction is required to enable the transportation, the interaction including certain authentications and/or commands from the transportee. Such applications may include certain security features such as time based command entry. For example, a user running the proprietary software on its smart device may have a certain time span, such as 10 seconds, in which to enter a desired floor, once the smart device authenticated itself with the elevator. Other transportation may include private, commercial and public motor vehicles.

The modules described herein may be applied to at least one of a door lock module, a garage door module, a car gate module, a software access module, a elevator control module, a vehicle control module, a parcel delivery cabinet and a locker control module. Here, the module affects entry, egress, access and the like, as per the particular application, in a manner as described herein.

Communication in the present embodiments may be affected by communication modules comprising network and communication chips, namely, semiconductor integrated circuits that use a variety of technologies and support different types of serial and wireless technologies as envisioned by the skilled person. Example serial technologies supported by the communication module include RS232, RS422, RS485, serial peripheral interface, universal serial bus, and USB on-the-go, Ethernet via RJ-45 connectors or USB 2.0. Example wireless technologies include code division multiple access, wide band code division multiple access, wireless fidelity or IEEE 802.11, worldwide interoperability for microwave access or IEEE 802.16, wireless mesh, and ZigBee or IEEE 802.15.4. Bluetooth® or NFC chips may be used to provide wireless connectivity in solution-on-chip platforms that power short-range radio communication applications. The communication module may be configured to operate using 3G, 4G or 5G technology standards, including: universal mobile telecommunications systems, enhanced data rates for global evolution and global system for global communication. The 4G standard is based solely on packet switching, whereas 3G is based on a combination of circuit and packet switching.

Processing in the present embodiments may be affected by processors disposed in communication with one or more memory devices, such as a RAM or a ROM, via a storage interface. The storage interface may connect to memory devices including, without limitation, memory drives, removable disc drives, etc., employing connection protocols such as serial advanced technology attachment, integrated drive electronics, IEEE-1394, universal serial bus, fiber channel, small computer systems interface, etc. The memory drives may further include a drum, magnetic disc drive, magneto-optical drive, optical drive, redundant array of independent discs, solid-state memory devices, solid-state drives, etc.

Memory devices may be used to store a collection of program or database components, including, without limitation, an operating system, a user interface application, a user/application data (e.g., any data variables or data records discussed in this disclosure), etc. The operating system may facilitate resource management and operation of the computer system. Examples of the operating system include, without limitation, Apple Macintosh OS X, Unix, Unix-like system distributions, Linux distributions, IBM OS/2, Microsoft Windows, Apple iOS, Google Android, Blackberry OS, or the like. The user interface may facilitate display, execution, interaction, manipulation, or operation of program components through textual or graphical facilities, including but not limited to touch screens. For example, user interfaces may provide computer interaction interface elements on a display system operatively connected to the computer system, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

It will be appreciated that, for clarity purposes, the above description has described embodiments of the technology described herein with reference to different functional units and processors. However, it will be apparent that any suitable distribution of functionality between different functional units, processors or domains may be used without detracting from the technology described herein. For example, functionality illustrated to be performed by separate processors or controllers may be performed by the same processor or controller. Such may be located on individual servers, co-located and the like as envisioned by the skilled person. Hence, references to specific functional units are only to be seen as references to suitable means for providing the described functionality, rather than indicative of a strict logical or physical structure or organization.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

1. A system for controlling access to a module-controlled location, the system comprising:
a backend configured to generate at least one digital key based upon a selected one of a plurality of escalating encryption security level encryption standards;
frontend arranged in communication with the backend, the frontend configured to establish an encrypted communication with the module and communicate the digital key and an access command to the module via the encrypted communication;
wherein the encryption standards comprise at least one key generator service based upon at least one of Payment Card Industry Data Security Standards and certified HSM.

2. The system according to claim 1, wherein the module is configured to authenticate the digital key and to execute the command if the digital key is authentic.

3. The system according to claim 2, wherein the front end further comprises a smart mobile device configured to affect the encrypted communication and generate digital keys.

4. The system according to claim 3, wherein each digital key is unique and assignable to a single user.

5. The system according to claim 4, wherein the module is an electronic lock.

6. The system according to claim 5, wherein the backend is configured to authenticate digital keys and communicate digital key authentication to the module.

7. The system according to claim 6, wherein the digital key is asymmetric, and the backend comprises a certification authority for attesting public keys.

8. The system according to claim 7, wherein communication within the backend is encrypted and the at least one digital key is generated in a virtual private data center with controlled access within the backend.

9. The system according to claim 8, wherein the backend is configured to generate a list of blacklisted digital keys and communicate the list to the module and the module is configured to query the list during digital key authentication.

10. The system according to claim 9, wherein the backend is configured to generate module maintenance information and communicate the module maintenance information directly to module and indirect to the module via at least one smart mobile device.

11. The system according to claim 10, wherein the module comprises at least one of a door lock module, a garage door module, a car gate module, a software access module, a elevator control module, a vehicle control module, a parcel delivery cabinet and a locker control module.

12. A method for controlling access to a module-controlled location, the method comprising the steps of:
generating in a backend at least one digital key based upon one of a plurality of escalating encryption security level encryption standards;
communicating the at least one digital key to a smart mobile device;
establishing an encrypted communication channel between the smart mobile device and the module;
communicating the at least one digital key and a module command to the module via the encrypted communication channel;
authenticating the at least one digital key at the module;
executing the module command with instructions on the key at the module if the at least one digital key is authentic and not executing the module command if the at least one digital key is not authentic; and
wherein the encryption standards comprise at least one key generator service based upon at least one of Payment Card Industry Data Security Standards and certified HSM.

13. The method according to claim 12, wherein the module is configured to authenticate the digital key and to execute the command with instructions on the key if the digital key is authentic.

14. The method according to claim 13, wherein the front end further comprises a smart mobile device configured to affect the encrypted communication and generate digital keys.

15. The method according to claim 14, wherein each digital key is unique and assignable to a single user for each lock.

16. The method according to claim 15, wherein the module is an electronic lock.

17. The method according to claim 16, wherein the backend is configured to authenticate digital keys and communicate digital key authentication to the module.

18. The method according to claim 17, wherein the digital key is asymmetric, and the backend comprises a certification authority for attesting public keys.

19. The method according to claim 18, wherein communication within the backend is encrypted and the at least one digital key is generated in a virtual private data center with controlled access within the backend.

20. The method according to claim 19, wherein:
the backend is configured to generate a list of blacklisted digital keys and communicate the list to the module and the module is configured to query the list during digital key authentication
the backend is configured to generate module maintenance information and communicate the module maintenance information directly to module and indirect to the module via at least one smart mobile device; and
the module comprises at least one of a door lock module, a garage door module, a car gate module, a software access module, a elevator control module, a vehicle control module, a parcel delivery cabinet and a locker control module.
